(19) United States
(12) Patent Application Publication
(10) Pub. No.: US 2006/0190379 A1
(43) Pub. Date: Aug. 24, 2006

(54) Price grabber

(76) Inventors: Eric Maas, Salt Lake City, UT (US); David Platt, Salt Lake City, UT (US); Jalali Hartman, Atlantic Beach, FL (US)

Correspondence Address: FENWICK & WEST LLP, SILICON VALLEY CENTER, 801 CALIFORNIA STREET, MOUNTAIN VIEW, CA, 94041, US

(21) Appl. No.: 11/361,514

(22) Filed: Feb. 23, 2006

Related U.S. Application Data
(60) Provisional application No. 60/655,780, filed on Feb. 23, 2005.

(51) Int. Cl. G06Q 40/00

(52) U.S. Cl. 705/35

(57) ABSTRACT

Systems and methods for automatic price monitoring of an online marketplace. The online marketplace is a virtual store (e.g., web-based) for buyers and sellers to exchange goods or products. A system includes a price monitoring module coupled to a market server, and buyer and seller devices. The price monitoring module retains a position garnered by a seller with the lowest price by periodically adjusting a subscribing seller's listing price to beat competing seller prices. The price monitoring module can be configured according to price parameters which gauge how much sellers are willing to concede. The price parameters can include, for example, a default listing price for a product, a decrement amount, a minimum listing price, and the like.

### CROSS-REFERENCES TO RELATED APPLICATIONS

The present application claims priority under 35 U.S.C. § 119(e) to U.S. Provisional Patent Application No. 60/655,780, filed on Feb. 23, 2005, entitled “Web Service—Price Grabber” which is incorporated by reference in its entirety.

### FIELD OF THE INVENTION

The present invention relates generally to online marketplaces, and more specifically, to price monitoring for improving product placement in the online marketplaces.

### BACKGROUND

Online marketplaces are substantial mediums for buyers and sellers of goods. For example, Amazon offers a wide inventory of books and other items through a web site. Buyers can browse or search the web site to find products of interest. On a web page containing the product, a variety of sellers offering the product can be listed, and are often ranked by their listing prices. As a result, a seller with the lowest price typically has the best placement among sellers. Since online buyers are not influenced by factors such as the ambience provided in physical marketplaces, the lowest price can often by the most important, if not the only, factor that influences buyer decisions.

Maintaining a high ranking on the online marketplace can be a burden-some task for sellers, especially those with large inventories. For example, after posting the initial product listings, sellers typically need to access web pages as presented to buyers in order to determine their product placement (e.g., as determined by their price ranking). If their product placement is not satisfactory, the sellers typically cancel the listing, and create a new listing with a price that is below the lowest minimum price. However, even after cutting the price, a competing seller can subsequently lower their price, thereby gaining a better product placement. Thus, sellers would need to constantly review product listings across their inventory.

Accordingly, a need exists for a system and method for improving product placement for a seller by maintaining (e.g., automatically) a lowest listing price.

### SUMMARY

The present invention addresses the above needs by providing systems and methods for price monitoring (e.g., automatically) of an online marketplace. The online marketplace is a virtual store (e.g., web-based) for buyers and sellers to exchange goods or products. In one embodiment, a system includes a price monitoring module coupled to a market server, and buyer and seller devices. The price monitoring module retains a position garnered by a seller with the lowest price by periodically adjusting a subscribing seller's listing price to beat competing seller prices. The price monitoring module can be configured according to price parameters which gauge how much sellers are willing to concede. The price parameters can include, for example, a default listing price for a product, a decrement amount, a minimum listing price, and the like. Advantageously, the subscribing seller can maintain an optimal product position over competing sellers by automatically maintaining the lowest price.

The features and advantages described in the specification are not all inclusive and, in particular, many additional features and advantages will be apparent to one of ordinary skill in the art in view of the drawings, specifications, and claims.

### BRIEF DESCRIPTION OF THE DRAWINGS

The teachings of the present invention can be readily understood by considering the following detailed description in conjunction with the accompanying drawings.

FIG. 1A is a block diagram of a system for price monitoring having a price monitoring module implemented within a price monitoring server by a third-party service provider according to several embodiments of the present invention.

FIG. 1B is a block diagram of the system for price monitoring having the price monitoring module implemented within a marketplace server by a marketplace service provider according to several embodiments of the present invention.

FIG. 1C is a block diagram of the system for price monitoring having the price monitoring module implemented within a seller device according to several embodiments of the present invention.

FIG. 2 is a block diagram of a price monitoring module in the system according to one embodiment of the present invention.

FIG. 3 is a block diagram of a price monitoring server in the system according to one embodiment of the present invention.

FIG. 4 is a block diagram of a seller interface to the price monitoring server as displayed on the seller device according to one embodiment of the present invention.

FIG. 5 is a block diagram of the marketplace server according to one embodiment of the present invention.

FIG. 6 is a block diagram of a buyer interface to the marketplace server as displayed on the buyer device according to one embodiment of the present invention.

FIG. 7 is a flow chart of a method for price monitoring according to one embodiment of the present invention.

FIG. 8 is a flow chart of a method for configuring product listings according to one embodiment of the present invention.

FIG. 9 is a flow chart of a method for adjusting a listing price for a product according to one embodiment of the present invention.

### DETAILED DESCRIPTION

Overview

Systems and methods for price monitoring of an online marketplace are described. The online marketplace is a virtual store (e.g., web based) for buyers and sellers to exchange goods or products. In one embodiment, a system for price monitoring automatically retains a position garnered by a seller with the lowest price. The process can be configured according to price parameters which gauge how much sellers are willing to concede. The price parameters can include, for example, a default listing price for a product, a decrement amount, a minimum listing price, and the like. As a result, a subscribing seller can maintain an optimal product position over competing sellers by maintaining the lowest price.

Exemplary Systems

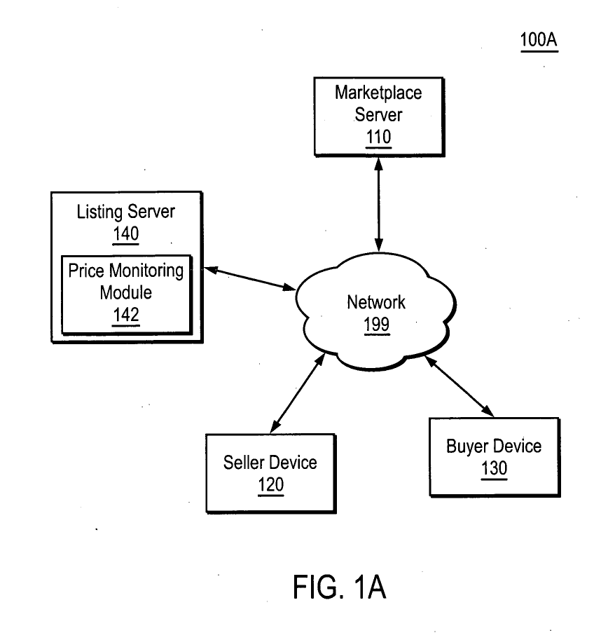

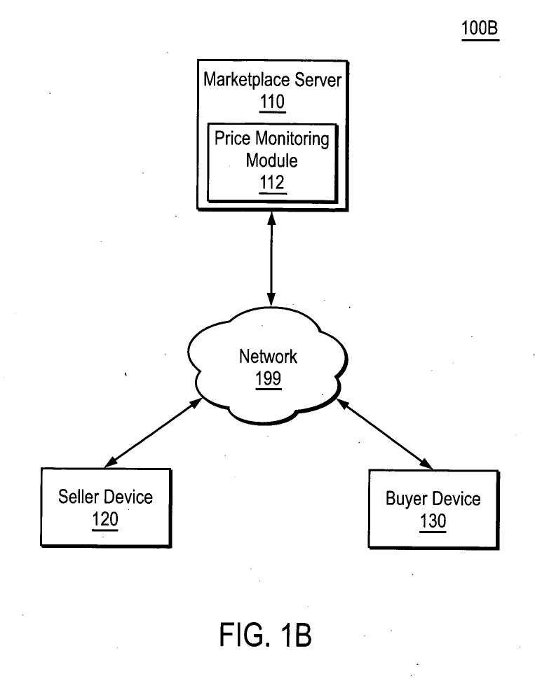

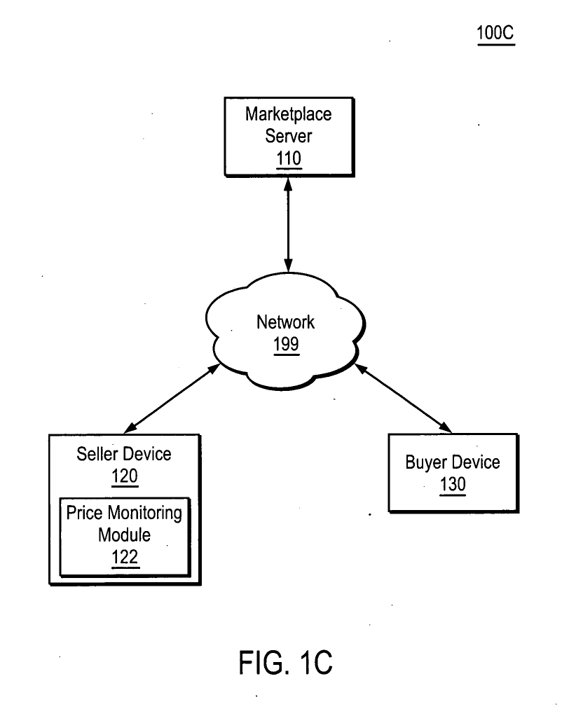

FIGS. 1A-C illustrate systems 100A-C for price monitoring according to some embodiments of the present invention. Systems 100A-C vary as to which network component implements price monitoring. Note that in other embodiments, price monitoring can be distributed across several components in cooperation.

In FIG. 1A, system 100A comprises a price monitoring server 110 with a price monitoring module 112, a marketplace server 120, a seller device 130, and a buyer device 140. The components can be, for example, personal computers or other processing devices capable of executing software instructions and capable of network communications. Seller and buyer devices 120, 130 can be mobile consumer devices such as mobile telephones, PDAs or laptop computers. The components are coupled in communication through a network 199.

Price monitoring server 110 receives price parameters from seller device 130 and sends listing commands (e.g., application programming interface, or API, commands) to marketplace server 120. Price monitoring server 112 of FIG. 1A can be operated by a third-party offering a price monitoring service. Price monitoring server 110 can also provide other services such as transaction automation, payment processing, inventory management, and delivery tracking as described below.

Price monitoring module 112 can be, for example, a software application comprising instructions stored on price monitoring server 110. In one embodiment, price monitoring module 112 automatically adjusts listing prices for a seller responsive to product placements when presented to a seller. For example, price monitoring module 112 can incrementally reduce (i.e., decrement) a listing price until it is the lowest listing price among competing sellers. Price monitoring server 110 and methods operating therein are discussed in greater detail below.

Marketplace server 120 receives listing commands from price monitoring server 110 and outputs views of the online marketplace (e.g., web pages) to buyer device 140. In one embodiment, marketplace server 120 hosts the online marketplace. The online marketplace is a virtual store for buyers and sellers to the exchange of goods. Buyers can peruse the online marketplace and make purchases. The online marketplace can be hosted by providers such as Amazon, E-Bay, Overstock, and the like. Products can include a variety of goods such as books, CDs, appliances, consumer electronics, and the like. Transactions can be, for example, traditional purchases for a set price, auctions, or reverse auctions. For example, a book can be offered for sale at different prices by different sellers on Amazon.com. During price monitoring for a subscribing seller, marketplace server 120 receives a request for prices at which competing sellers are offering the book. Subsequently, marketplace server 120 can receive a request to modify the book's listing price so that the subscribing seller now has the lowest price. In a resulting listing of sellers as viewed by buyers, the subscribing seller will appear first among the competing sellers. Marketplace server 120 and methods operating therein are discussed in greater detail below.

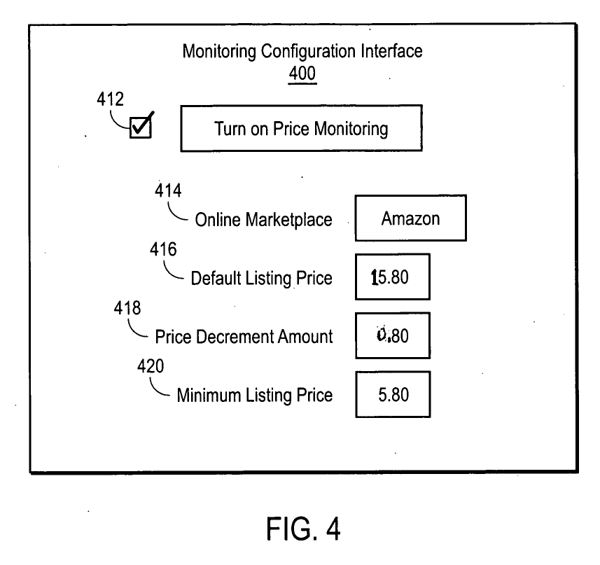

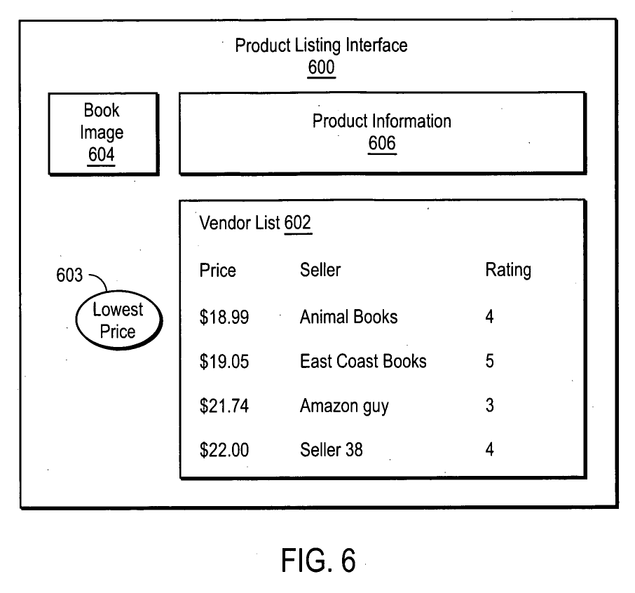

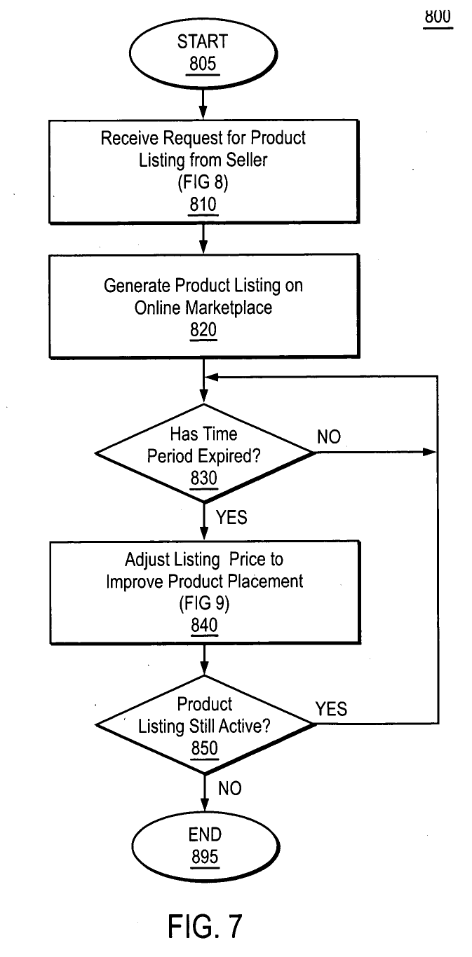

Seller device 130 allows sellers to interact with the online marketplace. Seller device 130 can include a keyboard or other mechanism for sellers to enter and change the price parameters through a web interface as shown in FIG. 4. Buyer device 140 allows buyers to interact with the online marketplace. Buyer device 140 can be similar to seller device 130 in displaying a web interface as shown in FIG. 6. Buyers using buyer device 140 can make purchase, bids, check shipping, and the like. Embodiments of seller and buyer devices 130, 140 are shown in FIGS. 7A-B.

Network 199 can be, for example, a data network (e.g., the Internet, an SMS network, etc.) or a telephone network (e.g., GSM). Network 199 can provide communications between nodes using protocols such as TCP/IP. For example, network 199 can transport data packets containing the price parameters and other information related to price monitoring, marketplace configuration and marketplace transactions.

FIG. 1B is a block diagram of system 100B for price monitoring having a price monitoring module 122 implemented within the marketplace server 120 by a marketplace service provider. In this configuration, price monitoring module 122 can be streamlined by integration into other marketplace services. Additionally, the marketplace service provider has more control over the features of price monitoring in the embodiment of FIG. 1B.

FIG. 1C is a block diagram of system 100C for price monitoring having the price monitoring module 132 implemented within seller device 130. Price monitoring module 132 can be a client executing as a background process such as a daemon or a toolbar of a web browser.

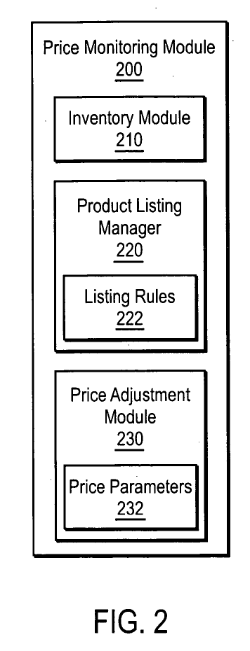

FIG. 2 is a block diagram of a price monitoring module 200 in more detail. Price monitoring module 200 comprises an inventory module 210, a product listing manager 220, and a price adjustment module 230. Price monitoring module 200 is representative of elements contained in price monitoring modules 112, 122, and 142. One of ordinary skill in the art would be able to make modifications based on the present disclosure.

Inventory manager 210 allows a seller to input product listings and the price parameters. More specifically, one embodiment of inventory module 210 display a monitoring configuration interface 400 comprising data entry elements such as text boxes and drop-down menus as shown in FIG. 4. Monitoring configuration interface 400 can be activated by a check box 412. An online marketplace 414 can be selected so that the appropriate listing rules can be accessed. The price parameters are set by inputting a default listing price 426, a price decrement amount 428, and a minimum listing price 430. Additional data entry elements can correspond to information needed to list products with the marketplace such as an International Standard Book Number (ISBN) identifier, a Stock Keeping Unit (SKU) number, a Universal Product Code (UPC), a bar code or other identifier, a starting or default price, a minimum price, and a price decrement amount. The SKU number can be a unique code defined by a manufacturer for tracking inventory. Inventory manager 210 can store the product listings in a persistent memory such as a hard drive. In the example of FIG. 4, a book is configured for sale on Amazon.com at a default listing price of $15.80. If the subscribing seller does not have the lowest price, the price will decrement by $0.80 until either the subscribing seller has the lowest price, or the minimum listing price of $5.80 is reached. Additionally, the price can be periodically checked to ensure the subscribing seller retains the lowest price.

Product listing manager 220 interfaces with one or more online marketplaces to create, modify, or delete product listings entered into inventory manager 210. Product listing manager 220 can use APIs and listing rules 222 that are associated with a particular marketplace. The listing rules 222 can specify how to execute the price parameters. In one embodiment, product listing manager 220 retrieves (e.g., periodically) information about existing product listings such as a competitor prices. Based on feed-back from price adjustment module, 230 product listing module 220 implements price adjustments.

Price adjustment module 230 uses price parameters to determine whether and how much prices should be adjusted. In one embodiment, price adjustment module 230 compares the lowest selling price of the competitors to the listing price of the seller. If the lowest selling price is lower, price adjustment module reduces the listing price below the lowest selling price according to the price decrement. Price adjustment module 230 outputs a new price to listing manager for posting to the online marketplace.

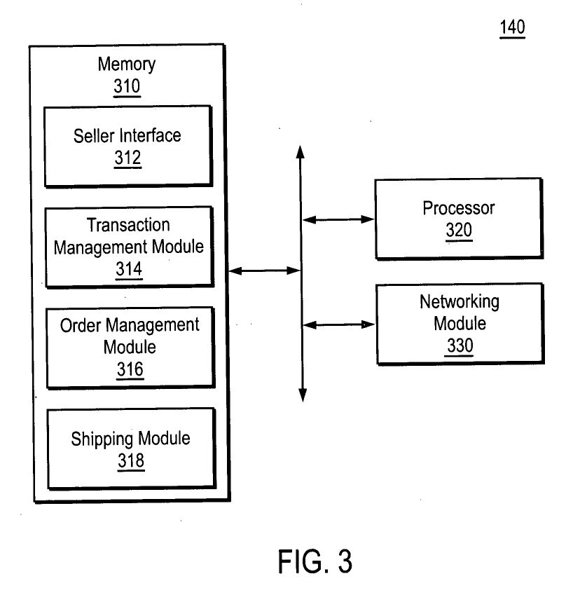

FIG. 3 is a block diagram of price monitoring server 140 in further detail. Price monitoring server 140 comprises a memory 310 including various modules, a processor 320, and a networking module 330.

Memory 310 can be, for example, a volatile storage (e.g., a RAM device), non-volatile storage (e.g., a hard disk or a flash memory), or combination. Memory 310 further includes seller interface 312 for providing access to buyers, a transaction management module 314 to process payments, an order management module 316 to match order to inventories, and a shipping module 318 to dispatch and track orders while en route to buyers.

Processor 320 can be, for example, a central processing unit or a controller. Processor 320 can execute instructions related to price monitoring and other functions from components in memory 310.

Networking module 330 can be, for example, a network interface card. Network module 330 can pack APIs and other monitoring data into data packets sent over network 199.

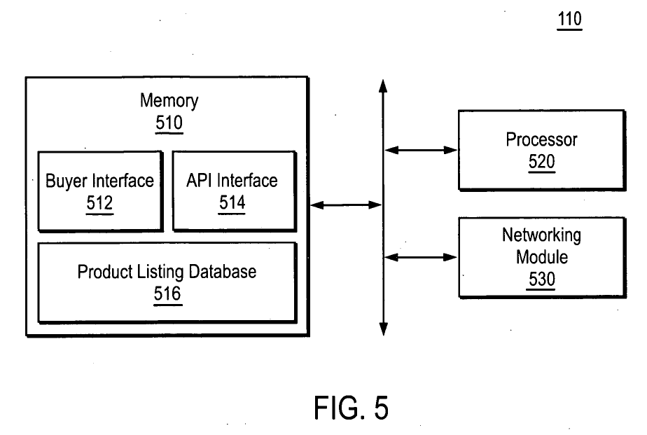

FIG. 5 is a block diagram of marketplace server 110 in greater detail. Marketplace server 110 comprises a memory 510 including various modules, a processor 520, and a networking module 530.

Memory 510 can be similar to memory 410 discussed above. Memory 510 further includes buyer interface 512, API interface 514, and product listing database 516. Buyer interface 512 generates a graphical representation of the online marketplaces for buyers. For example, buyer interface 512 can use a web page template (e.g., using HTML or XML) to display a product and related price information as shown in a product listing interface 600 of FIG. 6. Product listing interface 600 includes a vendor list 602, a lowest price icon 603, a book image 604, and product information 606. Vendor list 602 displays competing sellers ranked in order by the lowest listing price. Further, the lowest listing price has attention drawn to it by lowest price icon 603 which will draw buyers to that seller. Note that sellers can be ranked by additional factors such as seller ratings. It is contemplated that the present invention can be modified to take into account rating factors other than lowest price. Book image 604 can be a graphical representation of the book or other product. Product information 606 shows other data about the book such as author, year of publication, and the like.

API interface 614 receives API commands (e.g., simple object access protocol APIs such as Amazon APIs) to carry out actions related to the price parameters. The APIs can be made publicly available in open source or be proprietary. One command can be used to search a list of prices for a particular product (e.g., by SKU). Another command can be used to set a price of a product listing. Many additional commands are possible. Processor 520 and networking module 530 can be similar to processor 420 and networking module 430 described above.

Exemplary Methods

FIG. 7 is a flow chart of a method 700 for price monitoring according to one embodiment of the present invention. Method 700 can be implemented in a system for price monitoring (e.g., systems 100A-C).

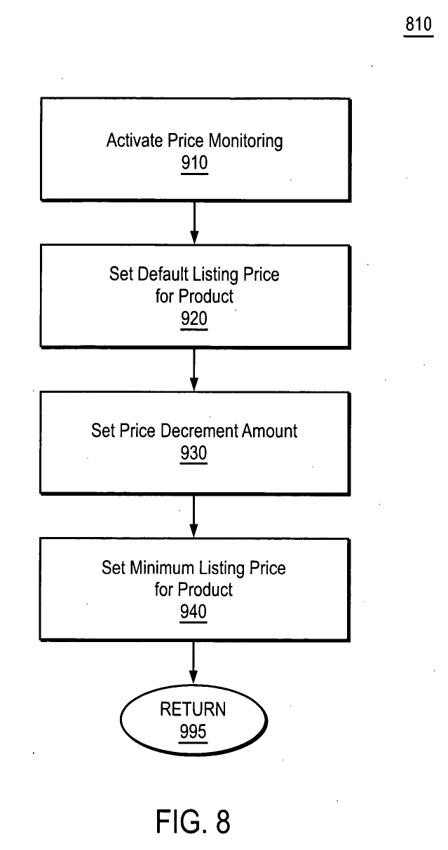

A listing server (e.g., listing server 140) receives 810 a request for a product listing from a seller as shown in FIG. 8. The listing server generates 820 a product listing on an online marketplace for access by buyers. Once a predetermined period of time has expired 830, the listing server adjusts 840 the listing price to improve product placement as shown in FIG. 10. The listing server continues to monitor the product listing price while the product listing is still active 850.

FIG. 8 is a flow chart of a method 810 for configuring one or more product listings according to one embodiment of the present invention. Method 810 can be implemented in an inventory module (e.g., inventory module 210) through a seller user interface (e.g., monitoring configuration interface 400).

The seller activates 910 price monitoring to initiate the process. For example, the user can select a check box in the monitoring configuration interface. In one embodiment, price monitoring is an optional service that operates among other services such as transaction management, order management, and shipping.

The seller sets 920 a default listing price for the product. The default listing price is a price at which the product is initially offered and can be set to, for example, a manufacturer's retail price, a desired sale price, or the like. The seller sets 930 a price decrement price. The decrement price represents the amount by which the product should exceed the lowest price of a competing seller. The seller sets 940 a minimum listing price for the product. The minimum listing price sets a floor for which the price should no longer be reduced.

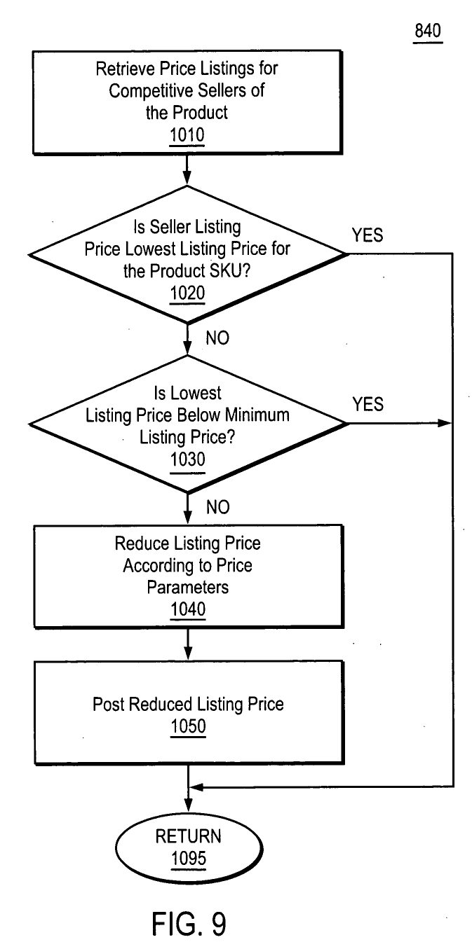

FIG. 9 is a flow chart of a method 840 for adjusting the listing price to improve product placement. In one example, product placement is linked to price in that the seller with the lowest price appears first in a list of sellers. Method 840 can be implemented in a price adjustment module (e.g., price adjustment module 230).

The price adjustment module retrieves 1010 price listings for competing sellers of the product (e.g., from marketplace server 110). The price listings can include just the lowest listing price, or all listing prices. In one embodiment, the price listings also include identifications of the competing sellers associated with the price listings. If the seller does not have the lowest listing price for the product SKU, the product placement may not be optimized.

As a result, the price adjustment module determines whether the lowest listing price is below the lowest minimum price 1030. If so, the price adjustment module reduces 1040 the listing price according price parameters (e.g., by decrement amount below the lowest listing price). Then, the price adjustment module posts 10f0 the reduced listing price on the marketplace server.

Note that in some embodiments, depending on listing rules (e.g., listing rules 222), the implementation details of method 840 can vary. For example, rather than modifying an existing listing price in order to post the reduced price, the listing may need to be cancelled and replaced by a new listing.

The order in which the steps of the methods of the present invention are performed is purely illustrative in nature. The steps can be performed in any order or in parallel, unless otherwise indicated by the present disclosure. The methods of the present invention may be performed in hardware, firmware, software, or any combination thereof operating on a single computer or multiple computers of any type. Software embodying the present invention may comprise computer instructions in any form (e.g., source code, object code, interpreted code, etc.) stored in any computer-readable storage medium (e.g., a ROM, a RAM, a magnetic media, a compact disc, a DVD, etc.). Such software may also be in the form of an electrical data signal embodied in a carrier wave propagating on a conductive medium or in the form of light pulses that propagate through an optical fiber.

While particular embodiments of the present invention have been shown and described, it will be apparent to those skilled in the art that changes and modifications may be made without departing from this invention in its broader aspect and, therefore, the appended claims are to encompass within their scope all such changes and modifications, as fall within the true spirit of this invention.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages can be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A computer-implemented method for product placement on an online marketplace, comprising:
receiving a listing request for a product offered online by a subscribing seller, the listing request including price parameters that indicate a default listing price and a minimum listing price;
receiving a lowest listing price of a competing seller for the product; and
responsive to the lowest listing price being lower than the default listing price, reducing the default listing price to at least the lowest listing price.

2. The method of claim 1, further comprising:
periodically requesting the lowest listing price.

3. The method of claim 1, further comprising:
determining whether the lowest listing price is lower than the minimum listing price,
wherein reducing the default listing price comprises responsive to the minimum listing price being lower than the lowest listing price, reducing the default listing price to at least the lowest listing price.

4. The method of claim 1, wherein the price parameters include a price decrement amount, and wherein reducing the lowest listing price comprises reducing the lowest listing price in accordance with the decrement amount.

5. The method of claim 1, wherein the listing request includes an International Standard Book Number (ISBN) identifier.

6. The method of claim 1, further comprising:
posting a product listing for access to buyers.

7. The method of claim 1, wherein the online marketplace is an online bookstore.

8. A method for product placement on an online marketplace, comprising:
receiving a listing request for a product offered online by a subscribing seller, the listing request including price parameters that indicate a default listing price and a minimum listing price;
receiving a plurality of listing prices associated with the product; and
adjusting the default listing price such that the subscribing seller is ranked highest among a plurality of sellers offering the product by having a lowest listing price among the plurality of listing prices.

9. A computer-readable medium storing a computer program product configured to perform a computer-implemented method for product placement on an online marketplace, the method comprising:
receiving a listing request for a product offered online by a subscribing seller, the listing request including price parameters that indicate a default listing price and a minimum listing price;
receiving a lowest listing price of a competing seller for the product; and
responsive to the lowest listing price being lower than the default listing price, reducing the default listing price to at least the lowest listing price.

10. The computer-readable medium of claim 9, wherein the method further comprises:
periodically requesting the lowest listing price.

11. The computer-readable medium of claim 9, wherein the method further comprises
determining whether the lowest listing price is lower than the minimum listing price,
wherein reducing the default listing price comprises responsive to the minimum listing price being lower than the lowest listing price, reducing the default listing price to at least the lowest listing price.

12. The computer-readable medium of claim 9, wherein the price parameters include a price decrement amount, and wherein reducing the lowest listing price comprises reducing the lowest listing price in accordance with the decrement amount.

13. The computer-readable medium of claim 9, wherein the listing request includes an International Standard Book Number (ISBN) identifier.

14. The computer-readable medium of claim 9, wherein the method further comprises:
posting a product listing for access to buyers.

15. The computer-readable medium of claim 9, wherein the online marketplace is an online bookstore.

16. A system for product placement on an online marketplace, comprising:
an inventory module configured to receive a listing request for a product offered online by a subscribing seller, the listing request including price parameters that indicate a default listing price and a minimum listing price;
a product listing manager, coupled in communication with the inventory module, the product listing manager configured to receive a lowest listing price of a competing seller for the product; and
a price adjustment module, coupled in communication with the product listing manager, the price adjustment module configured to, responsive to the lowest listing price being lower than the default listing price, reduce the default listing price to at least the lowest listing price.

17. The system of claim 16, wherein the product listing manager periodically requests the lowest listing price.

18. The system of claim 16, further comprising, wherein the price adjustment module determines whether the lowest listing price is lower than the minimum listing price, and responsive to the minimum listing price being lower than the lowest listing price, the price adjustment module reduces the default listing price to at least the lowest listing price.

19. The system of claim 16, wherein the price parameters include a price decrement amount, and wherein reducing the lowest listing price comprises reducing the lowest listing price in accordance with the decrement amount.

20. The system of claim 16, wherein the listing request includes an International Standard Book Number (ISBN) identifier.

21. The system of claim 16, wherein the product listing manager posts a product listing for access to buyers.

22. The system of claim 16, wherein the online marketplace is an online bookstore.
